(19) United States
(12) Patent Application Publication
(10) Pub. No.: US 2024/0300205 A1
(43) Pub. Date: Sep. 12, 2024

(54) METHOD OF MANUFACTURING LAMINATE, METHOD OF MANUFACTURING POLYMER THIN FILM, AND LAMINATE

(71) Applicant: Toray Industries, Inc., Tokyo (JP)

(72) Inventors: Yoshiaki Tominaga, Otsu-shi, Shiga (JP); Go Kondo, Otsu-shi, Shiga (JP); Satoko Morioka, Otsu-shi, Shiga (JP); Yohei Noda, Otsu-shi, Shiga (JP); Kiyoshi Minoura, Otsu-shi, Shiga (JP)

(73) Assignee: Toray Industries, Inc., Tokyo (JP)

(21) Appl. No.: 18/270,896

(22) PCT Filed: Jan. 17, 2022
(86) PCT No.: PCT/JP2022/001355

§ 371 Date: Jul. 5, 2023

(30) Foreign Application Priority Data
Feb. 5, 2021 (JP) 2021-017070

(51) Int. Cl. B32B 3/26; B32B 5/02; B32B 27/12; B32B 27/36; B32B 37/00; B32B 37/24; B32B 38/00

(52) U.S. Cl. CPC B32B 3/266; B32B 5/022; B32B 27/12; B32B 27/365; B32B 37/025; B32B 37/24; B32B 38/164; B32B 2037/243; B32B 2250/02; B32B 2262/0207; B32B 2319/00; B32B 2369/00

(57) ABSTRACT

A method of manufacturing a laminate includes: placing a mold having one surface on which a plurality of recesses are formed; applying a coating material to the one surface of the mold on which the recesses are formed, and dropping the coating material applied to portions of the recesses into the recesses while remaining the coating material applied to a portion of the one surface other than the recesses on the one surface of the mold; drying the coating material to form a polymer coating film having through-holes formed in portions corresponding to the recesses; pressing a support against the mold with the polymer coating film interposed between the support and the mold; and peeling the polymer coating film off together with the support from the mold to obtain a laminate including the support and the polymer coating film.

### CROSS REFERENCE TO RELATED APPLICATIONS

This application is the U.S. National Phase of PCT/JP2022/001355, filed Jan. 17, 2022, which claims priority to Japanese Patent Application No. 2021-017070, filed Feb. 5, 2021, the disclosures of these applications being incorporated herein by reference in their entireties for all purposes.

### FIELD OF THE INVENTION

The present invention relates to a method of manufacturing a laminate having a layer of a polymer coating film in which a plurality of through-holes having specific shapes are formed, the laminate, and a method of manufacturing a polymer thin film in which the through-holes having the specific shapes are formed.

### BACKGROUND OF THE INVENTION

In recent years, techniques for manufacturing film filters in which microscopic through-holes are formed are becoming increasingly important in various fields such as a medical field, a pathological diagnosis field, and an environmental field. Especially in the medical field and the pathological diagnosis field, film filters, in which single micron-sized through-holes arranged uniformly are formed, are required for highly efficient separation of cells of a specific size from blood samples or cell suspensions for diagnosis. In the environmental field, demand for filters in which microscopic through-holes are formed is high for separating viruses, bacteria, and asbestos, for example. As techniques for forming through-holes in resins, hole forming techniques using lasers, ion beams, and etching, and punching techniques using columnar molds have been proposed and applied to the development of products such as cell separation membranes and virus separation membranes.

For a film having through-holes, there is a method in which nano-sized to micron-sized through-holes are formed by emitting ion beams to form nano-sized through-holes, and then performing wet etching to enlarge the through-holes (e.g., Patent Literature 1).

For a film having through-holes, there is a method in which a polymer film, in which through-holes are formed, is obtained on a substrate by arranging particles having the same diameter as the through-holes on the substrate, creating a state in which the particles except their upper surfaces are covered with a liquid polymer material, and dissolving the particles after the polymer material has solidified (e.g., Patent Literature 2).

For a laminate having through-holes, there is a method in which a laminate having through-holes and including a nonwoven fabric and a hydrophobic polymer film, in which through-holes are formed, is obtained by generating water droplets in a liquid hydrophobic polymer material applied onto the nonwoven fabric and evaporating the water droplets after the hydrophobic polymer has solidified (e.g., Patent Literature 3).

### PATENT LITERATURE

Patent Literature 1: Japanese Patent Application Laid-open No. 2017-18881
Patent Literature 2: Published Japanese Translation of PCT Application No. 2013-540569
Patent Literature 3: Japanese Patent Application Laid-open No. 2012-6010

### SUMMARY OF THE INVENTION

However, in the method of manufacturing a film having through-holes described in Patent Literature 1, it is difficult to emit ion beams in an evenly arranged manner or to emit the beams accurately in a direction orthogonal to a surface of the film, and thus there is a problem that the pore diameters of the through-holes become random and adjacent through-holes merge together. The process is also complicated due to the need for etching after emitting of the ion beam, and thus there is also a problem that large facilities are required.

In the method of manufacturing a film having through-holes described in Patent Literature 2, it is difficult to arrange the particles for forming the through-holes at regular intervals on the substrate, and thus there is a problem that the arrangement of the through-holes becomes random. Furthermore, it is difficult to control the pore diameters because the diameters of the through-holes vary depending on the thickness of the polymer material when the particles are coated with the polymer material. In addition, the particles need to be dissolved at the end of the process, and thus there is a problem of low productivity.

In the method of manufacturing a laminate having through-holes described in Patent Literature 3, a hydrophobic solvent containing a polymer material is applied to a nonwoven fabric containing water, and water droplets are generated from inside the nonwoven fabric in the hydrophobic solvent containing the polymer material, whereby through-holes having the same size as the size of the water droplets are formed in the polymer material. However, in this method, it is difficult to arrange the water droplets at regular pitches, and it is also difficult to control the size of the droplets. This method is suitable for applications in which the size or the arrangement of through-holes does not particularly matter, but may cause a problem for a filter to effectively filter objects to be filtered having a specific size because the uniformity of the through-holes and the uniformity of the arrangement are required.

The present invention provides a method of manufacturing a laminate having a polymer coating film in which a plurality of through-holes having specific shapes are formed such that the size of the through-holes is uniform and the arrangement of the through-holes is uniform. The present invention also provides a method of manufacturing a polymer thin film in which the through-holes having the specific shapes are formed such that the size of the through-holes is uniform and the arrangement of the through-holes is uniform.

A method of manufacturing a laminate according to the present invention to solve the problem is a method of manufacturing a laminate having a layer of a polymer coating film in which a plurality of through-holes having specific shapes are formed. The method includes: placing a mold having one surface on which a plurality of recesses are formed, each recess having an opening shape that corresponds to a specific shape of a through-hole of the polymer coating film to be formed; applying a coating material to the one surface of the mold on which the recesses are formed, and dropping the coating material applied to portions of the recesses into the recesses while remaining the coating material applied to a portion of the one surface other than the recesses on the one surface of the mold; drying the coating material to form a polymer coating film having through-holes formed in portions corresponding to the recesses; pressing a support against the mold with the polymer coating film interposed between the support and the mold; and peeling the polymer coating film off together with the support from the mold to obtain a laminate including the support and the polymer coating film.

A method of manufacturing a polymer thin film according to the present invention includes peeling the polymer coating film off from a surface of the support of the laminate obtained by the method of manufacturing a laminate according to the present invention to obtain a polymer thin film in which a plurality of through-holes having specific shapes are formed.

In a laminate according to the present invention, a polymer coating film is directly stacked on one surface of a support having a plurality of through-holes, the polymer coating film being provided with a plurality of through-holes having specific shapes. A component that forms the polymer coating film does not penetrate into the through-holes of the support.

According to the present invention, after the through-holes having the uniform size and arrangement that are substantially the same as the opening shape of the recesses of the mold are formed in the polymer coating film, the polymer coating film is transferred onto the support, whereby the laminate having the layer of the polymer coating film in which the through-holes having the specific shapes are formed can be manufactured.

Lasers or ion beams for forming through-holes as in the conventional techniques are not used, and thus the cost of equipment for manufacturing can be reduced, resulting in lower manufacturing costs. The step of dissolving particles, for example, in a subsequent step to form through-holes can be omitted, and thus productivity can be improved without the need for a complicated process in the manufacturing of the laminate. In the present invention, because the shape and the size of the through-holes can be controlled so as to be substantially the same as the opening shape of the recesses of the mold, through-holes of various shapes can be formed by changing the opening shape of the mold to be used, and thus the scope of applications can be increased.

Furthermore, in the present invention, the polymer thin film can be efficiently, uniformly, and stably manufactured with the through-holes having the specific shapes.

### BRIEF DESCRIPTION OF DRAWINGS

FIG. 1 is a schematic diagram of an example of a laminate having a layer of a polymer coating film in which through-holes are formed, the laminate obtained by a method of manufacturing a laminate according to the present invention.

FIG. 2 is a schematic diagram of an example of a mold to be used in the present invention.

FIG. 3 is a diagram schematically illustrating the method of manufacturing a laminate according to the present invention.

FIG. 4 is a laser micrograph of a partial region of a surface of the mold in a process of manufacturing the laminate according to the present invention.

FIG. 5 is a schematic sectional view illustrating an example of a manufacturing apparatus that embodies the method of manufacturing a laminate according to the present invention.

### DETAILED DESCRIPTION OF EMBODIMENTS OF THE INVENTION

A method of manufacturing a laminate according to the present invention will be described with reference to the drawings. In the method of manufacturing a laminate according to the present invention, by performing: (1) a step of placing a mold having one surface on which a plurality of recesses are formed, each recess having an opening shape that is a specific shape; (2) a step of applying a coating material to the one surface of the mold on which openings are formed, and dropping the coating material applied to portions of the recesses into the recesses while remaining the coating material applied to a portion of the one surface other than the recesses on the one surface of the mold; (3) a step of drying the coating material to form a polymer coating film having through-holes formed in portions corresponding to the recesses; (4) a step of pressing a support against the mold with the polymer coating film interposed between the support and the mold; and (5) a step of peeling the polymer coating film off together with the support from the mold, in this order, a laminate having a layer of the polymer coating film in which the through-holes having the specific shapes are formed is obtained.

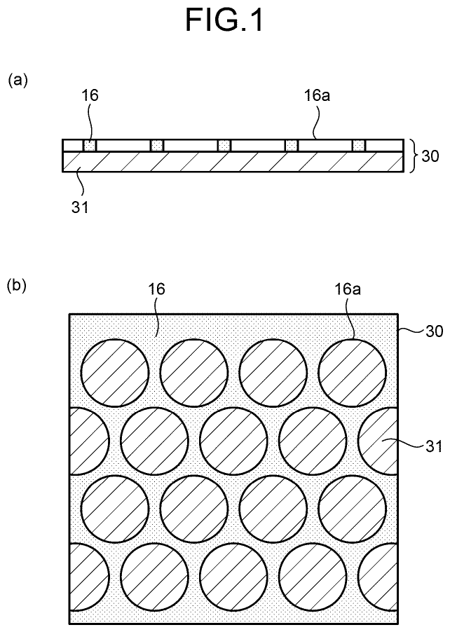

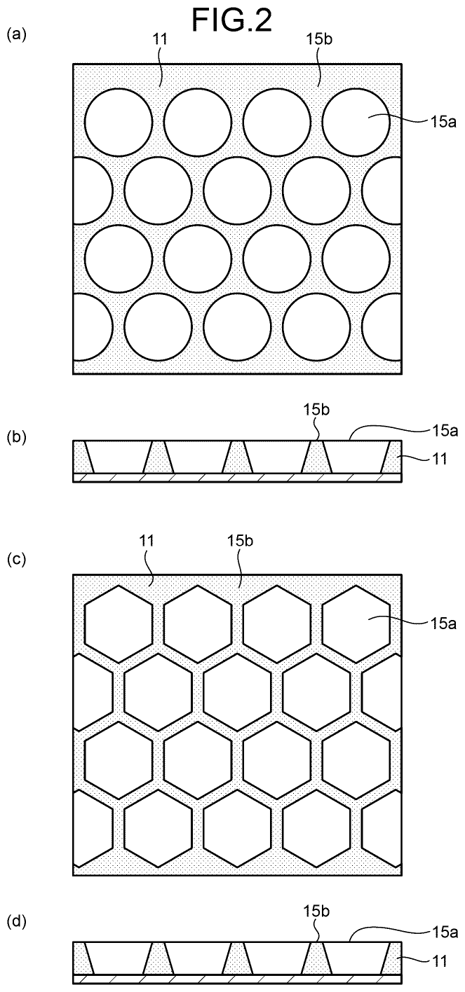

See FIG. 1. FIG. 1 is a schematic diagram of a laminate obtained by the method of manufacturing a laminate 30 according to the present invention. (a) of FIG. 1 is a schematic diagram of a cross section of the laminate 30, and (b) of FIG. 1 is a schematic diagram of the laminate 30 when viewed from above. As illustrated in (a) of FIG. 1, the laminate 30 has a structure in which a polymer coating film 16 and a support 31 are stacked and integrated. As illustrated in (b) of FIG. 1, when the laminate 30 is viewed from above, in the polymer coating film 16, through-holes 16a having substantially the same shape as the opening shape of recesses 15a of a mold 11 (see (a) of FIG. 2) are formed. When a mesh such as a nonwoven fabric is used for the support 31, by forming, in the support 31, holes the cross-sectional area of which is larger than the cross-sectional area of the through-holes 16a of the polymer coating film 16, the strength as a laminate can be increased without impairing the characteristics of the through-holes 16a of the polymer coating film 16.

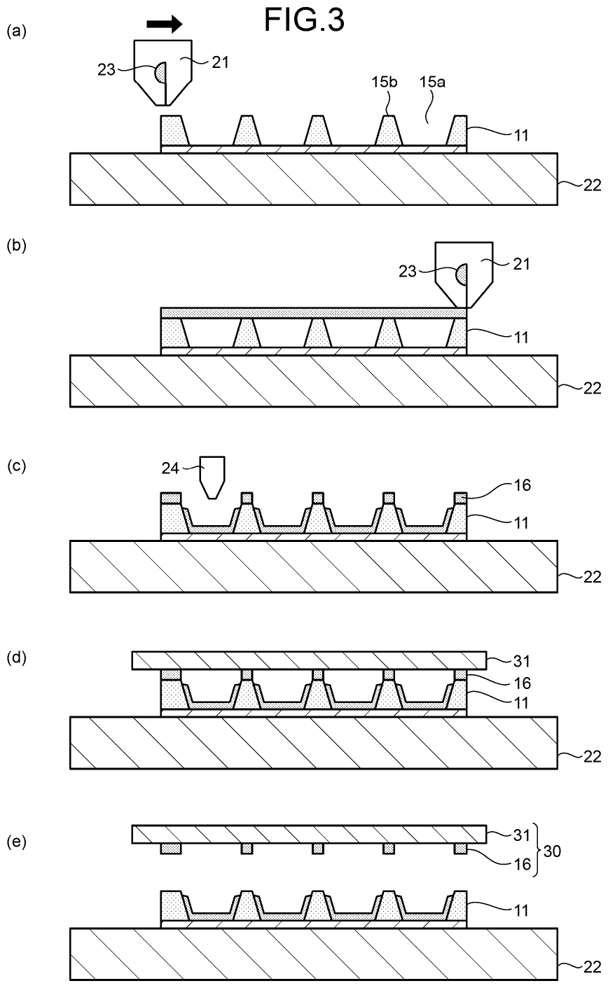

The following describes an example of the method of manufacturing the laminate 30 with reference to FIG. 2 and FIG. 3. FIG. 2 is a schematic diagram of an example of the mold to be used in the present invention. (a) of FIG. 2 is a plan view of a mold in which the opening shape of each recess is circular, (b) of FIG. 2 is a sectional view of the mold in which the opening shape of the recess is circular, (c) of FIG. 2 is a plan view of a mold in which the opening shape of each recess is polygonal, and (d) of FIG. 2 is a sectional view of the mold in which the opening shape of the recess is polygonal. As illustrated in FIG. 2, on one surface 15b of the mold 11, the recesses 15a are formed, and the opening shape of each recess 15a has a specific shape that is circular (see (a) of FIG. 2) or polygonal (see (c) of FIG. 2). Although not illustrated herein, an oval shape is also preferably used as the opening shape.

FIG. 3 is a diagram schematically illustrating the method of manufacturing a laminate according to the present invention. As a preparatory step, a coating material 23 containing a polymer material is prepared and charged into a tank of a coating-material feeding unit connected to a coating unit 21. The mold 11 is fixed on a flat stage 22, and is kept in a state of being suctioned onto the stage 22 by a vacuum generator (not illustrated).

Subsequently, the distance between a discharge end surface of the coating unit 21 and the surface 15b of the mold 11 is set at a predetermined distance, and the coating-material feeding unit is set such that conditions for feeding the coating material 23 correspond to conditions for a film thickness ((a) of FIG. 3).

Subsequently, a drive shaft and the coating-material feeding unit of the coating unit 21 are driven to uniformly apply the coating material 23 so as to cover at least the surface 15b of the mold 11. At this time, the coating material 23 is applied also to openings of the recesses 15a of the mold 11 ((b) of FIG. 3).

Subsequently, while remaining the coating material 23 on the surface 15b of the mold 11, the coating material 23 in the openings of the recesses 15a is dropped into the recesses 15a of the mold 11 by the self-weight of the coating material 23 or by a dropping unit 24 such that the coating material 23 remains only on the surface 15b of the mold 11 ((c) of FIG. 3).

The coating material 23 on the mold 11 is then dried to obtain a polymer coating film 16 in which the through-holes 16a having substantially the same shape as that of the surface 15b of the mold 11 are formed, that is, to obtain a polymer coating film 16 in which the through-holes 16a having substantially the same shape as the opening shape of the recesses 15a of the mold 11 are formed.

Subsequently, the support 31 is placed in a position facing the surface 15b of the mold 11 so as to be substantially parallel thereto, and a surface of the support 31 is brought into contact with the polymer coating film 16 by using a pressing unit (not illustrated) ((d) of FIG. 3).

Subsequently, by peeling the support 31 from the mold 11, the polymer coating film 16 is transferred from the surface 15b of the mold 11 to the surface of the support 31, and the laminate 30 including the support 31 and the polymer coating film 16 is obtained.

The mold 11 to be used in the manufacturing method according to the present invention is made of a material having chemical resistance to chemicals such as solvents to be used for the coating material 23, and preferably has a uniform thickness to ensure uniform application of the coating material 23. The expression “having chemical resistance” herein means that the modulus of volume change is 5% or less when the mold 11 is immersed in chemicals to be used for the coating material 23 for 72 hours at room temperature in a test according to JIS-K-6258 (2003 edition). Without chemical resistance, the surface of the mold 11 may be swollen by the chemicals and peeling of the polymer coating film 16 may be hindered, and thus it is preferable to have chemical resistance. As the material having chemical resistance, polyester resins such as polyethylene terephthalate, polyethylene-2,6-naphthalate, polypropylene terephthalate, polybutylene terephthalate; polyolefin resins such as polyethylene, polystyrene, polypropylene, polyisobutylene, polybutene, polymethylpentene; cyclo-olefin resins; polyamide resins; polyimide resins; polyether resins; polyesteramide resins; polyetherester resins; acrylic resins; polyurethane resins; polycarbonate resins; or polyvinyl chloride resins, for example, are preferably used.

The recesses 15a of the mold 11 are formed to have an opening shape that is substantially the same shape as those of the through-holes 16a wanted to be formed in the polymer coating film 16. The area of the opening shape (the opening area when viewed from the surface 15b side) is preferably within the range of 0.01 μm² to 100 μm², more preferably within the range of 0.25 μm² to 10 μm². The through-holes 16a each having a cross-sectional area of 0.01 μm² to 100 μm² are formed in the polymer coating film 16 and thus, when it is used as a filter, the pressure drop during filtration can be reduced while a specific size of objects to be filtered are being filtered. The depth of each recess 15a of the mold 11 is preferably within the range of 1 μm to 100 μm. If the depth is 1 μm or more, enough volume can be provided for the coating material 23 to be dropped thereinto, and thus the through-holes 16a can be formed without causing a situation in which the coating material 23 overflows from the recesses 15a to connect the polymer coating film 16 on the surface 15b to the recesses 15a of the mold 11. If the depth is 100 μm or less, it is not so difficult to prepare the mold 11, and thus problems in which the recesses 15a of the mold 11 deform and the surface 15b of the mold 11 becomes less smooth are less likely to occur.

The mold 11 can be prepared by any method that can impart a fine recessed shape to the film, such as thermal imprinting, UV imprinting, injection molding, and extrusion molding. The thermal imprinting in particular is preferably used because of its wide selection of mold materials to be used and high degree of flexibility in shape of the recesses. As the coating material 23, a polymer material, which is a main component of the polymer coating film 16, either melted by heat or dissolved by a solvent may be used. However, in consideration of the ease of application such as feeding and maintenance, a polymer material dissolved by a solvent is preferably used.

The coating unit 21 may be any unit that can apply the coating material 23 containing the polymer material uniformly onto the mold 11, and a slit die, a spin coater, a bar coater, and a dip coater are preferably used. However, the slit die is preferably used because it can also apply the coating material continuously to a mold in a roll form in particular.

In the step of dropping the coating material 23 into the openings of the recesses 15a of the mold 11, the polymer coating film 16 formed on the surface 15b of the mold 11 is preferably separated from polymer coating films formed on walls and bottoms of the recesses 15a of the mold 11. If the polymer coating film 16 formed on the surface 15b of the mold 11 is connected with the polymer coating films formed on the walls of the recesses 15a of the mold 11, the through-holes 16a may have a shape that is not the specific shape. If it is connected with the polymer coating films formed on the bottoms of the recesses 15a of the mold 11, the through-holes 16a may fail to be formed.

In the step of dropping the coating material 23 into the openings of the recesses 15a of the mold 11, the coating material 23 in the openings of the recesses 15a of the mold 11 after application may be allowed to fall spontaneously into the recesses 15a, or may be forcibly dropped into the recess 15a by using the dropping unit 24 such as vibration or air. When the coating material 23 in the openings of the recesses 15a is dropped into the recesses 15a spontaneously only by the self-weight of the coating material 23, it may take time for the coating material 23 to be dropped thereinto, depending on its physical properties. If it takes time to drop the coating material, by applying air to the surface of the mold 11 or applying vibration to the mold 11, only the coating material 23 in the openings of the recesses 15a can be dropped into the recesses 15a quickly with the coating material 23 on the surface 15b retaining its shape.

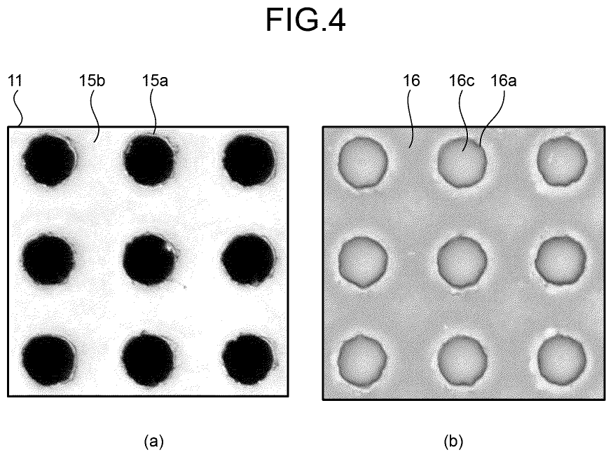

An example of a laser micrograph of a partial region of the surface of the mold 11 in a process of manufacturing the laminate according to the present invention is illustrated in FIG. 4. (a) of FIG. 4 is a laser micrograph of a partial region of the surface 15b of the mold 11, which was cut and taken, before the coating material 23 was applied. (b) of FIG. 4 is a laser micrograph of a partial region of the polymer coating film 16, which was cut and taken, formed on the mold 11. In (a) of FIG. 4, the surface 15b of the mold 11 is white and the recesses 15a are black. In (b) of FIG. 4, the polymer coating films 16 and 16c are white. As illustrated in (a) and (b) of FIG. 4, the coating material 23 is uniformly applied to the surface 15b of the mold 11 to form the polymer coating film 16, and in the recesses 15a of the mold 11, the polymer coating films 16c formed from the coating material 23 dropped through the openings are accumulated on the sides and the bottoms of the recesses 15a. The boundary between the polymer coating film 16 and each polymer coating film 16c is black, which indicates that polymer coating film 16 is not connected with the polymer coating films 16c. By transferring only the polymer coating film 16 on the surface 15b of the mold 11 to the support 31, the laminate including the polymer coating film 16, which has through-holes 16a having substantially the same shape as the openings of the recesses 15a of the mold 11, and the support 31 can be obtained.

The support 31 according to the present invention preferably has adhesive strength to peel the polymer coating film 16 from the surface 15b of the mold 11 and to adhere tightly to the support 31. Without adhesive strength, the polymer coating film 16 may remain on the mold 11 side without being peeled off from the surface 15b of the mold 11, or even after being peeled off therefrom, the polymer coating film may fall off without being integrated with the support 31.

As a material to be used for the support 31 having adhesion, for example, styrene butadiene rubber-based, silicone-based, ethylene vinyl acetate copolymer-based, polyolefin-based, amorphous polyalphaolefin-based, synthetic rubber-based, polyamide-based, polyester-based, or polyurethane-based resins are preferably used. If the support 31 is made of a material that does not have adhesion, by heating and thermally bonding the polymer coating film 16 and the support 31 or by applying treatment to the polymer coating film 16 or the support 31, adhesiveness between the polymer coating film 16 and the support 31 can be increased. As a treatment method of increasing the adhesiveness of the polymer coating film 16 or the support 31, a wet process such as impregnating the polymer coating film 16 or the support 31 with an adhesive may be used, or a dry process by surface modification such as corona treatment or plasma treatment may be used. As a material of the support 31 that does not have adhesion, metallic materials such as stainless steel, nickel, aluminum, copper, and brass are also preferably used.

The support 31 preferably has through-holes the cross-sectional area of which is larger than that of the through-holes 16a of the polymer coating film 16. Specifically, when the laminate 30 is observed from the support 31 side, the ratio (S2/S1) between the opening area S1 (μm²) of one through-hole of the support 31 and the sum S2 (μm²) of the opening areas of the through-holes 16a of the polymer coating film 16 observed through this one through-hole is preferably 0.05 or more. When S2/S1 is 0.05 or more, air or liquid entering the laminate 30 from the polymer coating film 16 side can easily pass through the laminate 30 without being blocked by either the polymer coating film 16 or the support 31, and thus the pressure drop across the laminate 30 can be reduced and the characteristics of the through-holes of the polymer coating film 16 can be utilized. S2/S1 is more preferable 0.1 or more. Although the upper limit of S2/S1 is not limited to a particular value, S2/S1 is preferably 0.5 or less because if the area of a portion other than the through-holes 16a in the polymer coating film 16 is small and the thickness of the polymer coating film 16 is thin, the polymer coating film 16 may stretch or break due to insufficient strength. When S2/S1 is 0.5 or less, the area of the portion of the polymer coating film 16 other than the through-hole 16a is large enough to ensure the strength of the polymer coating film 16. S2/S1 is more preferably 0.3 or less. As the support 31, a substrate having through-holes such as a nonwoven fabric or a mesh can be used. However, a mesh is preferably used because the opening shape of the through-holes of the support 31 can be easily controlled therewith.

The pressure drop across the support 31 when gas or liquid is filtered is preferably smaller than the pressure drop across the polymer coating film 16. If the pressure drop across the support 31 is smaller than that across the polymer coating film 16, the pressure drop across the laminate 30 is not much different from that across the polymer coating film 16, and thus the characteristics of the through-holes 16a can be utilized for the laminate 30 without impairing filtration.

The opening shape of each through-hole 16a of the polymer coating film 16 is substantially the same as the opening shape of each recess 15a of the mold 11. The opening shape of the through-hole 16a of the polymer coating film 16 is circular when the opening shape of the recess 15a of the mold 11 is circular, the former is polygonal when the latter is polygonal, and the former is oval when the latter is oval. For example, when the laminate 30 is used for filtration, the shape of the through-hole 16a of the polymer coating film 16 can be changed by selecting the opening shape of the mold 11 in accordance with the shape and hardness of the object to be filtered.

If the polymer coating film 16 does not wrinkle or is not torn when it has been peeled off from the support 31 and handled as a separate film, a polymer thin film 17 in which the through-holes are formed can be obtained by peeling the polymer coating film 16 off from the support 31 of the laminate 30.

The polymer material to be used as the polymer coating film 16 is not limited to a particular one. However, polyester resins such as polyethylene terephthalate, polyethylene-2,6-naphthalate, polypropylene terephthalate, polybutylene terephthalate; polyolefin resins such as polyethylene, polystyrene, polypropylene, polyisobutylene, polybutene, polymethylpentene; polyamide resins; polyimide resins; polyether resins; polyesteramide resins; polyetherester resins; acrylic resins; polycarbonate resins; or polyvinyl chloride resins, for example, are preferably used.

In the method of manufacturing a laminate having through-holes according to the present invention, the laminate 30 is manufactured by applying the coating material 23 onto the mold 11 in which the recesses 15a are formed, and then transferring the polymer coating film 16 on the surface 15b of the mold 11 onto the support 31. In this case, the mold 11 in a sheet form may be used, or a mold in a roll form may be used. The use of the mold in a roll form is characterized by its superiority in productivity over the use of the mold 11 in a sheet form.

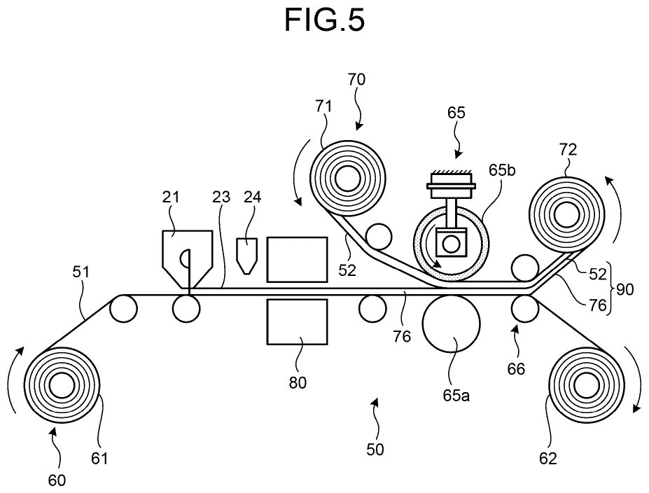

The laminate according to the present invention can be manufactured by a process using an apparatus illustrated in FIG. 5, for example. FIG. 5 is a schematic sectional view of an example of the manufacturing apparatus for manufacturing a laminate 90 in a roll form, illustrating an apparatus using a mold 51 in a roll form.

A series of manufacturing operations to be performed by an apparatus 50 for manufacturing the laminate 90 is as follows. The mold 51 in a roll form is set in a state of being unwound from an unwinding roll 61, passing through a path along the coating unit 21, a drying unit 80, a transfer unit 65, and a peeling unit 66, and being wound onto a winding roll 62. A support 52 in a roll form is set in a state of being unwound from an unwinding roll 71, passing through a path along the transfer unit 65 and the peeling unit 66, and being wound onto a winding roll 72. The mold 51, to which a certain tension necessary for conveyance by a mold feeding unit 60 is applied, is conveyed at a predetermined speed by the rotation of a drive roll 65b. The support 52, to which a certain tension necessary for conveyance by a support feeding unit 70, is nipped and pressed together with the mold 51 by the drive roll 65b and a nip roll 65a in the transfer unit 65, is conveyed while being in close contact with the mold 51, is then peeled off from the mold 51 by the peeling unit 66, and is wound up onto the winding roll 72. While the mold 51 and the support 52 are being conveyed, the coating material 23 is applied by the coating unit 21 so as to cover the surface of the mold 51 on which recesses are formed. Subsequently, the dropping unit 24 drops the coating material 23 in openings of the recesses of the mold 51 into the recesses. Subsequently, the coating material 23 is dried by the drying unit 80 to obtain a polymer coating film 76 in which through-holes having substantially the same shape as the surface of the mold 51, that is, substantially the same shape as the opening shape of the recesses of the mold 51. Subsequently, the transfer unit 65 brings the mold 51 and the support 52 into close contact with each other with the polymer coating film 76 interposed between the support 52 and the mold 51. Subsequently, by the peeling unit 66, the polymer coating film 76 is transferred from the surface of the mold 51 to the support 52 side to obtain the laminate 30 including the support 52 and the polymer coating film 76. The mold 51 from the surface of which the polymer coating film 76 has been peeled is wound directly onto the winding roll 62, and the laminate 90 in a roll form is wound onto the winding roll 72. The above-described operations are performed continuously.

In the laminates 30 and 90 obtained by the method of manufacturing a laminate according to the present invention, the polymer coating films 16 and 76 are directly stacked on the surfaces of the supports 31 and 52, respectively, without an adhesive layer or the like interposed between the supports 31 and 52 and the polymer coating films 16 and 76. During the process of manufacturing of the laminates 30 and 90, the coating material 23 that is a component of the polymer coating films 16 and 76 is not applied to the surfaces of the supports 31 and 52, and thus the polymer material that forms the polymer coating films 16 and 76 does not penetrate into the through-holes of the supports 31 and 52. In the method of manufacturing a laminate described in Patent Literature 3 above, a hydrophobic solvent containing polymer material is applied to a nonwoven fabric, and thus the polymer material inevitably penetrates into openings in the nonwoven fabric, and the openings in the nonwoven fabric that is a support layer of the resulting laminate become smaller due to the polymer material that has penetrated. As a result, when the laminate is used for filtration, the effective area for filtration decreases. In the laminates 30 and 90 according to the present invention, components that form the polymer coating films 16 and 76 do not penetrate into the through-holes of the supports 31 and 52, and thus the opening areas of the through-holes of the polymer coating films 16 and 76 and the opening areas of the through-holes of the supports 31 and 52 can be set as designed, and the filtration performance can be obtained as designed when the laminates 30 and 90 are used for filtration.

### EXAMPLES

### Example 1

A cyclo-olefin polymer-based film (trade name: ZeonorFilm ZF14, manufactured by Zeon Corporation) was used as the material for the mold 11. The structure of each recess 15a of the mold 11 had a columnar shape having an opening shape of a circle with a diameter of 3 μm and a depth of 10 μm. The recesses 15a were arranged in a square arrangement at pitches of 10 μm. The mold 11 was prepared such that the width and the length thereof were both 100 mm, and was set on a vacuum suction board to be suctioned and secured so that the coating material 23 could be applied thereto.

As the material for the support 31, SBS (trade name: TUFPRENE A, Asahi Kasei Corporation) having adhesion was used, which was processed into a nonwoven fabric by using a melt spinning device.

As the coating material 23, polycarbonate (manufactured by Mitsubishi Engineering-Plastics Corporation), which is a polymer material, dissolved in acetone (CAS No. 67-64-1 manufactured by FUJIFILM Wako Pure Chemical Corporation) was used, and was prepared such that the concentration of the polycarbonate to the total coating material 23 was 5.0 mass %.

The distance between the coating unit 21 and the surface of the mold 11 was set to 100 μm, and the coating material 23 was applied at a discharge rate such that the resulting thickness of the polymer coating film 16 after drying became 800 nm. After the application, the coating material 23 was dropped into the recess 15a of the mold 11 by the self-weight of the coating material 23.

The high volatility of acetone was utilized for drying, and the polymer coating film 16 was formed by drying using a drying space at a temperature controlled to be constant at 40° C.

The support 31 and the polymer coating film 16 were stacked so as to be in contact with each other, and were pressed at a pressure of 0.2 MPa for 60 seconds.

Subsequently, the support 31 was peeled off from the mold 11, and the polymer coating film 16 was transferred to the support 31 to obtain a laminate including the support 31 and the polymer coating film 16.

As a result of observation of the obtained laminate, it was confirmed that, in the polymer coating film 16, through-holes having substantially the same shape as the opening shape of the recesses 15a of the mold 11 were formed.

### Example 2

The same materials as in Example 1 were used for the mold 11 and the coating material 23. The structure of each recess 15a of the mold 11 had a columnar shape having an opening shape of a square with a side of 10 μm and a depth of 5 μm. The recesses 15a are arranged in a square arrangement at pitches of 15 μm. The mold 11 was prepared such that the width and the length thereof were both 100 mm, and was set on a vacuum suction board to be suctioned and secured so that the coating material 23 could be applied thereto.

As the material for the support 31, a nylon mesh (manufactured by SEFER) with a wire diameter of 51 μm and an aperture of 100 μm was used.

The distance between the coating unit 21 and the surface of the mold 11 was set to 100 μm, and the coating material 23 was applied at a discharge rate such that the resulting thickness of the polymer coating film 16 after drying became 1 μm. After the application, the coating material 23 was dropped into the recess 15a of the mold 11 by the self-weight of the coating material 23.

The high volatility of acetone was utilized for drying, and the polymer coating film 16 was formed by drying using a drying space at a temperature controlled to be constant at 40° C.

The supports 31 and the polymer coating film 16 were stacked so as to be in contact with each other, and were pressed at a pressure of 0.2 MPa for 60 seconds while being heated at 130° C.

Subsequently, the support 31 was peeled off from the mold 11, and the polymer coating film 16 was transferred to the support 31 to obtain a laminate 30 including the support 31 and the polymer coating film 16.

As a result of observation of the obtained laminate 30, in the polymer coating film 16, through-holes having substantially the same shape as the opening shape of the recesses 15a of the mold 11 were formed. When the laminate 30 was observed from the support 31 side, it was confirmed that the ratio (S2/S1) between the opening area S1 (μm²) of one through-hole of the support 31 and the sum S2 (μm²) of the opening areas of the through-holes of the polymer coating film 16 observed through this one through-hole was 0.07.

### INDUSTRIAL APPLICABILITY

The laminate obtained by the method of manufacturing a laminate according to the present invention has a layer of a polymer coating film having through-holes of a uniform size that are open at a high aperture ratio, which allows filtering of objects of a specific size. For example, it is ideally suitable as a filter for separating or fractionating rare cells in blood samples, rare cells in cell suspensions, or the like. By selecting a material with high transparency, separated cells can be observed through the filter directly, and thus can be used for pathological diagnosis.

### REFERENCE SIGNS LIST

11, 51 MOLD
15a RECESS
15b SURFACE
16, 16c, 76 POLYMER COATING FILM
17 POLYMER THIN FILM
21 COATING UNIT
22 STAGE
23 COATING MATERIAL
24 DROPPING UNIT
30, 90 LAMINATE
31, 52 SUPPORT
50 MANUFACTURING APPARATUS
60 MOLD FEEDING UNIT
61, 71 UNWINDING ROLL
62, 72 WINDING ROLL
65 TRANSFER UNIT
65a NIP ROLL
65b DRIVE ROLL
66 PEELING UNIT
70 SUPPORT FEEDING UNIT
80 DRYING UNIT

1. A method of manufacturing a laminate having a layer of a polymer coating film in which a plurality of through-holes having specific shapes are formed, the method comprising:
placing a mold having one surface on which a plurality of recesses are formed, each recess having an opening shape that corresponds to a specific shape of a through-hole of the polymer coating film to be formed;
applying a coating material to the one surface of the mold on which the recesses are formed, and dropping the coating material applied to portions of the recesses into the recesses while remaining the coating material applied to a portion of the one surface other than the recesses on the one surface of the mold;
drying the coating material to form a polymer coating film having through-holes formed in portions corresponding to the recesses;
pressing a support against the mold with the polymer coating film interposed between the support and the mold; and
peeling the polymer coating film off together with the support from the mold to obtain a laminate including the support and the polymer coating film.

2. The method of manufacturing a laminate according to claim 1, wherein the opening shape of each recess is circular, oval, or polygonal.

3. The method of manufacturing a laminate according to claim 1, wherein the support has adhesive strength.

4. The method of producing a laminate according to claim 1, wherein a pressure drop across the support is smaller than a pressure drop across the polymer coating film.

5. A method of manufacturing a polymer thin film, comprising peeling the polymer coating film off from a surface of the support of the laminate obtained by the method of manufacturing a laminate according to claim 1 to obtain a polymer thin film in which a plurality of through-holes having specific shapes are formed.

6. A laminate in which a polymer coating film is directly stacked on one surface of a support having a plurality of through-holes, the polymer coating film being provided with a plurality of through-holes having specific shapes, wherein
a component that forms the polymer coating film does not penetrate into the through-holes of the support.

7. The laminate according to claim 6, wherein the specific shape of each through-hole is circular, oval, or polygonal.

8. The laminate according to claim 6, wherein, when the laminate is observed from a side of the support, a ratio (S2/S1) between an opening area S1 (μm²) of one through-hole of the support and a sum S2 (μm²) of opening areas of the through-holes of the polymer film observed through the one through-hole is 0.05 or more.

9. The laminate according to claim 8, wherein the ratio (S2/S1) is 0.5 or less.
